(19) United States
(12) Patent Application Publication
(10) Pub. No.: US 2008/0174620 A1
(43) Pub. Date: Jul. 24, 2008

(54) SYNTHETIC JETS

(75) Inventor: Edward T. Tanner, Williamsburg, VA (US)

Correspondence Address: NIXON & VANDERHYE, PC, 901 NORTH GLEBE ROAD, 11TH FLOOR, ARLINGTON, VA, 22203, US

(73) Assignee: AdaptivEnergy, LLC., Hampton, VA (US)

(21) Appl. No.: 11/866,889

(22) Filed: Oct. 3, 2007

Related U.S. Application Data
(60) Provisional application No. 60/827,932, filed on Oct. 3, 2006.

(51) Int. Cl. B41J 29/38

(52) U.S. Cl. 347/10

(57) ABSTRACT

A synthetic jet comprises structure (comprising at least one piezoelectric member) for defining a fluid chamber; a nozzle configured to provide fluid communication between the fluid chamber and external to the fluid chamber; and, a drive source connected to apply an electrical signal to the piezoelectric member in a manner whereby activation of the piezoelectric member causes zero net flux of fluid with respect to the fluid chamber.

This application claims the priority and benefit of U.S. Provisional Patent Application 60/827,932, filed Oct. 3, 2006, entitled PIEZOELECTRICALLY DRIVEN SYNTHETIC JETS, which is incorporated herein by reference in its entirety.

### BACKGROUND

1. Field of the Invention

The present invention pertains to synthetic jets, and particularly to synthetic jets that are piezoelectrically driven.

2. Related Art and Other Considerations

A synthetic jet is a device that is designed to produce extremely high velocity jets of gas. Examples of synthetic jets are described in, e.g., the following U.S. Pat. Nos. 5,758,823; 5,894,990; 5,988,522; and 6,457,654, all of which are incorporated by reference herein. Some synthetic jets produce zero net flux of pumped fluid (e.g., the intake and exhaust volumes from the device are equal on each stroke, allowing, e.g., the devices to be used in a sealed enclosure).

There has been considerable interest in synthetic jets recently as, e.g., the popularity of portable electronic devices has increased and with it the demand for smaller, lighter, and longer battery life devices. Synthetic jets offer a unique solution to the various issues encountered with these and other devices.

### BRIEF SUMMARY

In an example embodiment, a synthetic jet comprises means for defining a fluid chamber, the means for defining the fluid chamber comprising at least one piezoelectric member; a nozzle configured to provide fluid communication between the fluid chamber and external to the fluid chamber; and, a drive source connected to apply an electrical signal to the piezoelectric member in a manner whereby activation of the piezoelectric member causes zero net flux of fluid with respect to the fluid chamber.

In an example implementation, the means for defining the fluid chamber comprises a first piezoelectric member and a second piezoelectric member which have their circumferences connected together substantially entirely around a circumference of the means for defining the fluid chamber. An edge of the first piezoelectric member and an edge of the second piezoelectric member exert a force against each other when displaced.

In an example implementation, the nozzle is situated to extend through the circumference of the means for defining the fluid chamber. In another example implementation, the nozzle is situated to extend axially through the means for defining the fluid chamber.

In an example implementation, the nozzle is configured to have an interior passage which in cross section is either converging, diverging, or tapered for increasing velocity of a fluid exiting through the nozzle from the fluid chamber.

Some example implementations further comprise means for operating the synthetic jet at a low frequency. The means for operating the synthetic jet at a low frequency can take various forms. In one example implementation, the means for operating the synthetic jet at the low frequency comprises a mass connected to the piezoelectric member to increase deflection magnitude of the piezoelectric member upon activation. In another example implementation the means for operating the synthetic jet at the low frequency comprises a shim positioned on the piezoelectric member to increase deflection magnitude of the piezoelectric member upon activation, the shim having a larger radius than a piezoceramic layer of the piezoelectric member. In yet another example implementation, the means for operating the synthetic jet at the low frequency comprises the drive source being configured to apply the electrical signal to the piezoelectric member so that the synthetic jet operates at a sub-KHz frequency. These example implementations can be used either individually or collectively.

In an example implementation, the drive source is configured to apply the electrical signal having a drive waveform configured to provide a predetermined air exit velocity from the nozzle. For example, in one example implementation the drive waveform is configured to provide a higher dV/dt on a compression stroke than on an intake stroke.

In another example embodiment a synthetic jet assembly comprises a housing configured to define a fluid chamber; a displaceable diaphragm situated in the housing (the housing having a port defined therein for permitting ingress and egress of fluid to the fluid chamber); a conduit connected to the port; a drive source connected to apply an electrical signal to the diaphragm member; and, plural nozzles or orifices formed in the conduit. Activation of the diaphragm serves to operate the plural nozzles or orifices as plural synthetic jets driven by a single actuator. The drive source is connected to apply the electrical signal to the diaphragm member in a manner whereby the activation of the diaphragm facilitates creation of a standing pressure wave in the conduit. Preferably the plural nozzles or orifices are spaced apart at positions corresponding to pressure anti-nodes of the standing pressure wave.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a cross sectioned side view of a first example embodiment of a synthetic jet.

FIG. 2 is a cross sectioned side view of a second example embodiment of a synthetic jet.

FIG. 3 is a cross sectioned side view of a third example embodiment of a synthetic jet.

FIG. 4 is a cross sectioned side view of a fourth example embodiment of a synthetic jet.

FIG. 5 is a cross sectioned side view of a fifth example embodiment of a synthetic jet.

FIG. 6 is a cross sectioned side view of a sixth example embodiment of a synthetic jet.

FIG. 7 is a cross sectioned side view of a seventh example embodiment of a synthetic jet assembly.

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

Described herein are example embodiments of synthetic jets, many of which utilize a ruggedized laminated piezoelectric member. A ruggedized laminated piezoelectric member comprises a piezoceramic layer, and can be of the type in which metallic electrodes are formed on opposite major surfaces of the piezoceramic layer. The piezoceramic layer (with electrodes optionally formed thereon) is laminated or bonded to at least one metallic layer, and may in fact be laminated in sandwich fashion between two metallic layers (e.g., between a stainless steel layer and an aluminum layer, for example).

Non-limiting examples of such ruggedized laminated piezoelectric members are provided in PCT Patent Application PCT/US01/28947, filed 14 Sep. 2001; U.S. patent application Ser. No. 10/380,547, filed Mar. 17, 2003, entitled “Piezoelectric Actuator and Pump Using Same”; U.S. patent application Ser. No. 10/380,589, filed Mar. 17, 2003, entitled “Piezoelectric Actuator and Pump Using Same”, and U.S. patent application Ser. No. 11/279,647, entitled “PIEZOELECTRIC DIAPHRAGM ASSEMBLY WITH CONDUCTORS ON FLEXIBLE FILM”, all of which are incorporated herein by reference.

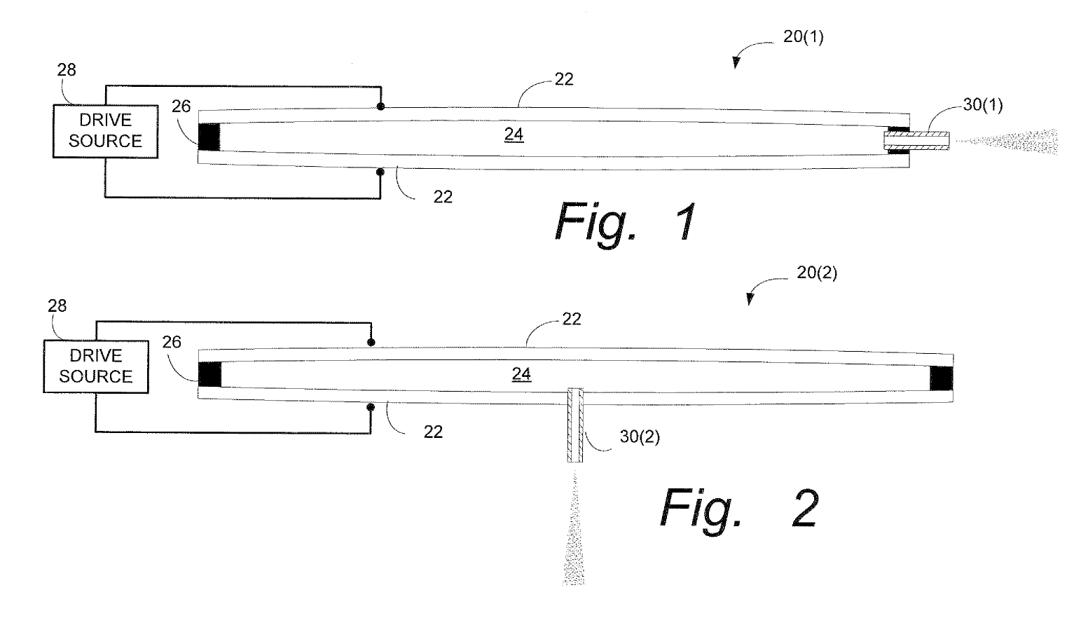

FIG. 1 and FIG. 2 show, in cross section side view, two example embodiments of synthetic jets 20(1), 20(2) which comprise ruggedized, laminated piezoelectric members 22 which have their peripheral edges connected together for forming a fluid chamber 24 therebetween. Preferably the laminated piezoelectric members 22 are circular, and thus have their circumferences connected together substantially entirely around the entire circumference. As such, the laminated piezoelectric members 22 of each synthetic jet acquire an essentially bellows or clam shell configuration.

The connection of the peripheries of the two laminated piezoelectric members 22 can be by any suitable means, as represented by connection seam 26. The connection seam 26, and thus the connectivity, can be realized by, e.g., an adhesive or other bonding or material or clamping fixture. Preferably connection seam 26 is formed flexibly, e.g., as with a flexible adhesive.

The two laminated piezoelectric members 22 are positioned to be actuated in an opposed manner. In other words, the two laminated piezoelectric members 22 are positioned and operated so that substantially in unison the two laminated piezoelectric members 22 are operated or actuated to deflect outwardly away from each other for enlarging the volume of air chamber 24 or are essentially simultaneously operated or actuated toward each other for reducing the volume of fluid chamber 24. The bond formed essentially around peripheries of the first piezoelectric member edge and the second piezoelectric member edge forms a fluid chamber between the first piezoelectric diaphragm and the second piezoelectric diaphragm and in a manner whereby an edge of the first piezoelectric member and an edge of the second piezoelectric member exert a force against each other when displaced.

To this end, each of the laminated piezoelectric members 22 are connected to a drive source 28. In an example embodiment, drive source 28 comprises an electrical circuit suited for applying voltage to laminated piezoelectric members 22, and in some embodiments may include one or more controllers or processors. The electrical signal applied to one or more piezoelectric members of the synthetic jet causes deflection or movement of the piezoelectric members, result in a compression stroke in which fluid is expelled from the fluid chamber and an intake stroke in which fluid enters the fluid chamber.

The synthetic jets 20(1) and 20(2) each have a nozzle, but differ in the respective placement or location of the nozzle. The synthetic jet 20(1) of FIG. 1 has its nozzle 30(1) situated to extend through and preferably protrude from the circumferential edge of the device, e.g., through seam 26. Other than to allow for protrusion of nozzle 30(1) in the embodiment of FIG. 1, the circumferential seams 26 of both embodiments are substantially continuous. On the other hand, synthetic jet 20(2) of FIG. 2 has its nozzle 30(2) protruding or extending in an axial direction through one of its laminated piezoelectric members 22, and preferably extending axially through a center of the laminated piezoelectric members 22. The FIG. 2 embodiment may be advantageous in applications that are space constrained in the axial direction of the synthetic jet. For example, moving the nozzle to align with the center of the piezoelectric member as shown in FIG. 2 as opposed to the edge (as shown in FIG. 1) can allow for a low profile synthetic jet which would be more ideally suited to printed circuit board (PCB) applications than a disk standing on edge protruding from the PCB.

The drive source 28 is connected to apply an electrical signal to one or more piezoelectric members 22 in a manner whereby activation of the piezoelectric member causes zero net flux of fluid with respect to the fluid chamber 24, e.g., zero net flux of fluid through the nozzle as the piezoelectric member(s) 22 are operated or actuated. Although for sake of simplicity and clarity drawings of ensuing embodiments may not illustrate a drive source such as drive source 28 being connected to one or more piezoelectric members, it will be appreciated that a drive source is provided in each embodiment and is connected by electrical connectors/conductors or the like to the one or more piezoelectric members utilized in the respective embodiments.

Through proper design of the nozzle, or through the use of other means of tuning that will be discussed later, these bellows-like devices synthetic jets 20 can be designed to operate at low frequencies. A converging/diverging nozzle such as a De Laval nozzle, or even a simple tapered nozzle, would provide increased flow velocities over the straight nozzles that are typically utilized in synthetic jets. In other words, the in some example embodiments the nozzle is configured to have an interior passage which in cross section is either converging, diverging, or tapered for increasing velocity of a fluid exiting through the nozzle from the fluid chamber.

Traditionally synthetic jets have operated at Helmholtz resonant frequencies which are in the kHz range for this scale of device. While operating at this frequency has the potential to improve the flow from the synthetic jet, acoustically such a high frequency device can be objectionable. In embodiments described herein, including the synthetic jet 20(1) of FIG. 1 and the synthetic jet 20(2) of FIG. 2, the drive frequency of the device can be tuned to operate at far lower frequencies, e.g., at sub-KHz frequencies (i.e., frequencies less than 1 KHz). In this regard, in example embodiments the drive source 28 is preferably configured to supply a drive signal at 60 Hz or lower to each of the laminated piezoelectric members 22. Operation at 60 Hz or lower avoids detection by the human ear.

Another advantage to operating at 60 Hz is the potential to drive the device directly from line voltage thus minimizing the drive circuitry required in AC applications. A further benefit of low frequency operation is decreased power consumption which is an obvious advantage in battery-powered applications.

Vibration amplification techniques can be utilized to increase flow from the synthetic jets. Vibration amplification can be provided by a Dynamic Vibration Absorber (DVA) drive system or a Reverse Vibration Absorber (RVA) drive system. These vibration amplification techniques can considerably increase the displacement of the laminated piezoelectric members 22 to 20-30 times the standard operating displacement. When coupled to a synthetic jet, these drivers can significantly increase the flow from the synthetic jet and allow operation at far lower frequencies.

FIG. 3 illustrates an example embodiment of an RVA-driven synthetic jet 20(3). In the synthetic jet 20(3) of FIG. 3, the fluid chamber 24 is defined by a diaphragm, membrane, or other flexible, moving member 40 positioned within a housing. In the particular embodiment shown in FIG. 3, diaphragm 40 is secured between an upper housing member 42 and a lower housing member 44. The lower housing member 44 has opening or nozzle 30(3) formed therein, with opening or nozzle 30(3) positioned so that vortices discharged from fluid chamber 24 emanate in a direction essentially perpendicular to the radial direction of membrane 40.

The fluid chamber 24 of the synthetic jet 20(3) of FIG. 3 is also known as a compression chamber. The fluid chamber 24 is formed between a first surface of diaphragm 40 and an interior surface of lower housing member 44. Another chamber, i.e., chamber 50, is provided between a second surface of diaphragm 40 and an interior upper surface of upper housing member 44. The laminated piezoelectric member 22 of the synthetic jet 20(3) is situated in chamber 50, preferably with its circumference secured (e.g., to the housing). A spring 52 or other elastic member is secured between laminated piezoelectric member 22 and the second or non-fluid contacting surface of diaphragm 40. For example, the spring 52 or other elastic member has a first end secured, connected, or mounted to a central underside portion of laminated piezoelectric member 22, and a second end similarly secured, connected, or mounted to a central upperside portion of diaphragm 40.

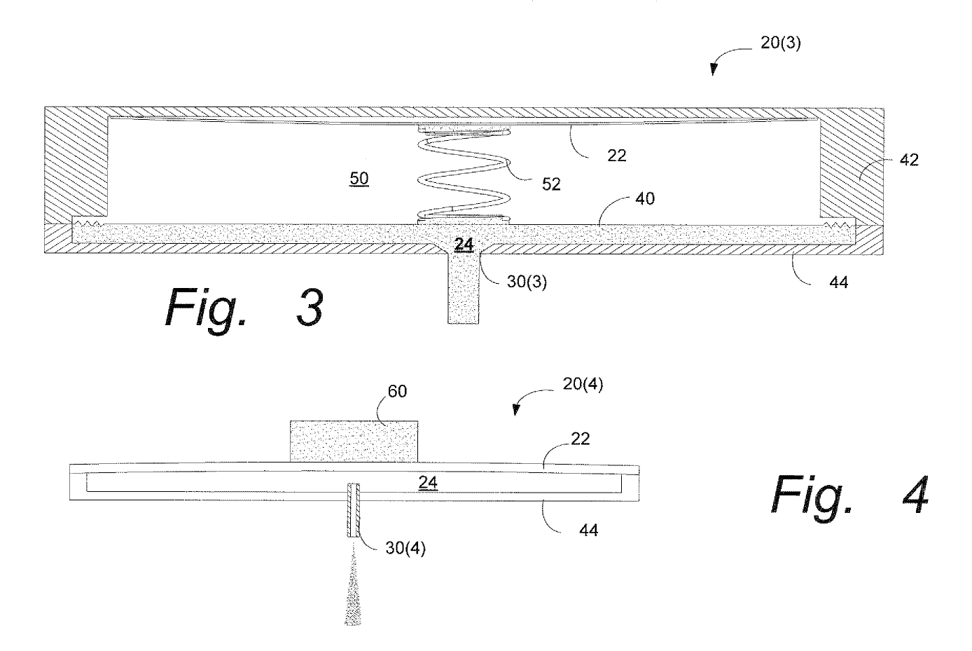

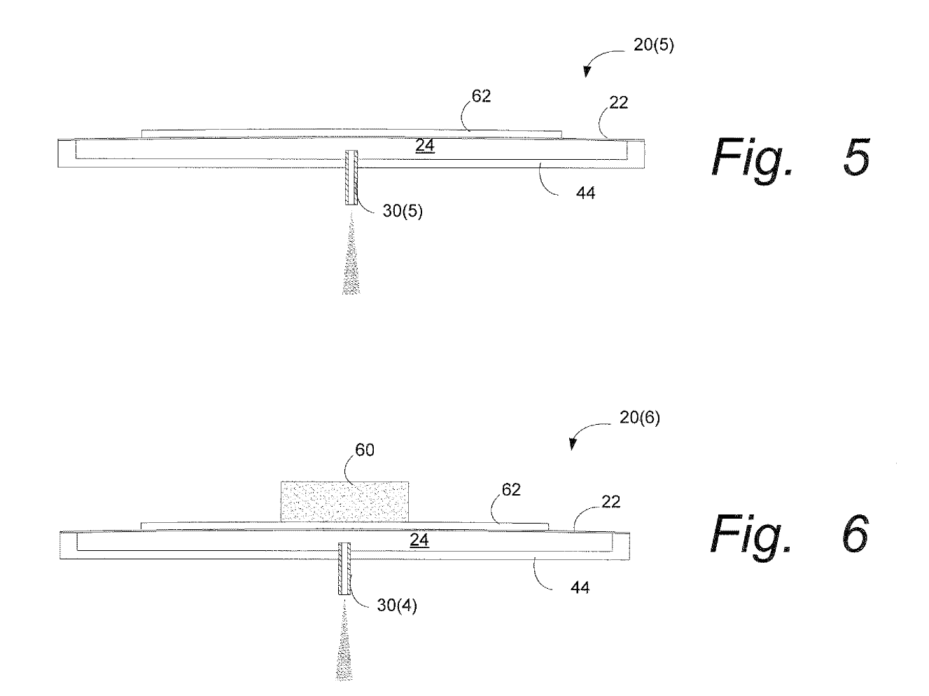

Another technique for both lowering the operating frequency and increasing the flow from synthetic jets of the type described (and through increased deflection) is by adding a mass to the laminated piezoelectric member 22 and/or extending a shim further past the piezoceramic disk on the laminated piezoelectric member 22. FIG. 4 illustrates an example embodiment of a synthetic jet 20(4) wherein an additional mass 60 is placed or positioned (e.g., connected, secured or adhered) on a laminated piezoelectric member 22 for lowering resonant frequency. In the example embodiment of FIG. 4, the fluid chamber 24 is defined between laminated piezoelectric member 22 and bottom housing member 44. The nozzle 30(4) extends orthogonally from the bottom housing member 44 (i.e., in an axial direction of laminated piezoelectric member 22).

FIG. 5 illustrates another example embodiment of a synthetic jet 20(5) wherein an extended shim 62 is placed or positioned (e.g., connected, secured or adhered) on a laminated piezoelectric member 22 for lowering resonant frequency. In the example embodiment of FIG. 5, the fluid chamber 24 is defined between laminated piezoelectric member 22 and bottom housing member 44. The nozzle 30(5) extends orthogonally from the bottom housing member 44 (i.e., in an axial direction of laminated piezoelectric member 22). In an example embodiment, shim 62 is preferably comprised of stainless steel. As such, the shim 62 may comprise an existing one of the laminated layers of the laminated structure of laminated piezoelectric member 22. In the FIG. 5 embodiment, the shim 62 extends radially past (e.g., has a larger radius) than a piezoceramic layer of the laminate.

FIG. 6 illustrates an example embodiment of a synthetic jet 20(6) having both of additional mass 60 and an extended shim 62 placed or positioned (e.g., connected, secured or adhered) on a laminated piezoelectric member 22 for lowering resonant frequency.

Since these devices are most efficient when operating at their resonant frequencies, and power consumption is proportional to the drive frequency, it is desirable to lower the resonant frequency of the device. Another benefit of lowering the resonant frequency is decreased noise from the device. If the resonant frequency is lowered to 60 Hz or below the device becomes essentially inaudible to the human ear. From a simplified viewpoint these devices can be considered as a single degree-of-freedom oscillator. The resonant frequency of a single degree-of-freedom oscillator is described by Equation 1.

$$ω = \sqrt{\frac{k}{m}} \qquad Equation 1$$

In Equation 1, k is the stiffness of the laminated piezoelectric member 22 and m is the effective mass of the laminated piezoelectric member 22. Considering Equation (1) it can be seen that the resonant frequency can be lowered by either decreasing the stiffness of the laminated piezoelectric member 22, and/or increasing the effective mass. Decreasing the stiffness of the laminated piezoelectric member 22 can be accomplished by extending the shim further, in the radial direction, past the piezoceramic disk as in FIG. 5 and FIG. 6 whereas increasing the effective mass can be achieved by adding mass to the laminated piezoelectric member 22 as in FIG. 4 and FIG. 6.

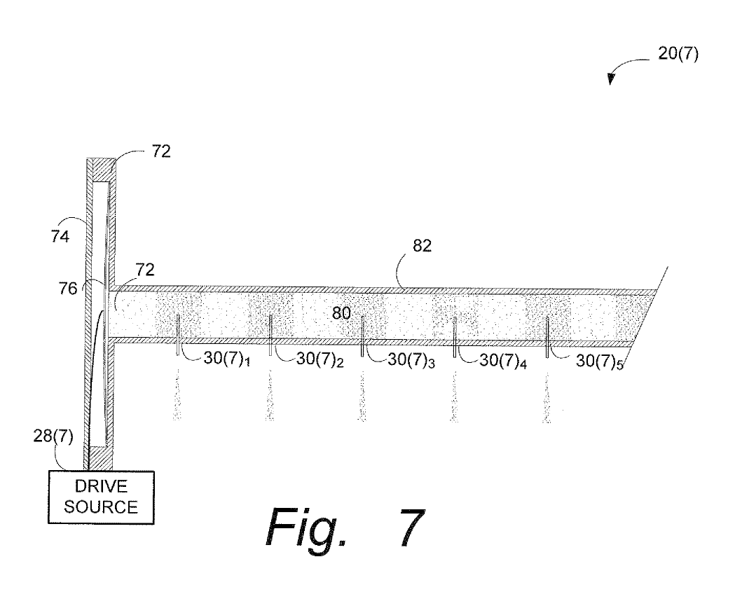

FIG. 7 illustrates an example embodiment of a synthetic jet assembly 20(7) which utilizes a concept of a multi-port standing wave device. The synthetic jet assembly 20(7) comprises a housing having mating housing members 72 and 74. Preferably the housing is in the form or shape of a disk or cylinder. A moveable diaphragm 76 is situated in the housing for defining a fluid chamber between a fluid-contacting surface of the diaphragm 76 and an interior surface of housing member 72. The housing member 72 has a port 78 formed thereon for permitting ingress and egress of fluid into diaphragm 76. The port 78 communicates with a fluidic passage 80 formed in a conduit 82. In the illustrated example embodiment conduit 82 is preferably tubular and extends substantially parallel to an axial direction of diaphragm 76, e.g., extends substantially perpendicular to the major surface of housing member 72. Provided along conduit 82 are a series of orifices or nozzles 30(7)₁ through 30(7)_{N}, orifices or nozzles 30(7)₁ through 30(7)₅ being shown for sake of example in FIG. 7. In an example implementation, the nozzles 30(7)₁ through 30(7)_{N} are spaced apart at positions corresponding to pressure anti-nodes. Different geometries of conduit 82, including different shapes and different arrangements/spacings for nozzles 30(7)₁ through 30(7)_{N}, are possible in other embodiments.

The diaphragm 76 of the synthetic jet assembly 20(7) of FIG. 7 can be a laminated piezoelectric member 22 as before mentioned, or other suitable flexible member or material.

The synthetic jet assembly 20(7) of FIG. 7 thus employs a single diaphragm 76 to drive multiple synthetic jets (e.g., multiple nozzles 30(7)) located along a tube (e.g., conduit 82). This is accomplished by setting up standing pressure waves in the tube 82 through excitation by the diaphragm 76. Standing waves can be set up by driving the diaphragm 76 at the resonant frequency of the tube 82 (which can be easily determined). The jets or nozzles 30(7) are then located at positions along the tube corresponding to pressure anti-nodes. At these locations the pressure within the standing wave will oscillate sinusoidally and provide the pumping action for the individual jets. By proper design of the tube 82 and adjustment of the drive frequency (at/by drive source 28(7)), the jets or nozzles 30(7) can be located exactly where they are needed in a particular application. It is not necessary for the tube 82 to be straight. In fact, tube 82 can be bent as needed to place the jets or nozzles 30(7) appropriately for a given application.

In the embodiment of FIG. 7, the diaphragm is preferably, but need not necessarily be, a piezoelectric element such as the ruggedized laminated piezoelectric member described above.

Among other applications, this synthetic jet assembly 20(7) of FIG. 7 allows a single diaphragm or actuator (such as a laminated piezoelectric member 22, for example) to cool multiple hot spots in an electronic cooling application such as a laptop computer. Another potential use is boundary layer control on aircraft wings. Controlling the boundary layer on an aircraft wing promises to considerably increase the fuel efficiency of aircraft. Considerable research funding has been funneled into this concept, but to date the synthetic jets utilized have been individual devices. Since thousands of these synthetic jets would be required on an aircraft wing, it is very useful to have a means whereby multiple synthetic jets could be driven by a single actuator. Having multiple jets located along a tube simplifies the design of the system as well.

There are several advantages to synthetic jet devices such as those described herein. For example, they can be designed to be very small thus allowing their use in portable electronic devices. They can be battery powered which again is useful in portable electronics.

Examples of drive electronics (e.g., drive sources) are included among those described in U.S. patent application Ser. No. 10/816,000 (attorney docket 4209-26), filed Apr. 2, 2004 by Vogeley et al., entitled “Piezoelectric Devices and Methods and Circuits for Driving Same”, which is incorporated herein by reference in its entirety, or by documents referenced and/or incorporated by reference therein.

The bonding or securing of two piezoelectric diaphragms in an oyster shell or bellows arrangement (with peripheries bonded or adhered together) is further understood with reference to U.S. patent application Ser. No. 11/024,943, filed Dec. 30, 2004, entitled “PUMPS WITH DIAPHRAGMS BONDED AS BELLOWS”, which is incorporated herein by reference in its entirety.

Examples of vibration amplification (for a piezoelectric member) in the form of a dynamic vibration absorber (DVA) drive system or a reverse vibration absorber (RVA) drive system are described, e.g., in one of more of the following: U.S. patent application Ser. No. 11/747,450, entitled “Compressor and Compression Using Motion Amplification”, U.S. PATENT application Ser. No. 11/747,469, entitled “MOTION AMPLIFICATION USING PIEZOELECTRIC ELEMENT”, and U.S. patent application Ser. No. 11/747,516, entitled “VIBRATION AMPLIFICATION SYSTEM FOR PIEZOELECTRIC ACTUATORS AND DEVICES USING THE SAME”, all of which is incorporated herein by reference in their entirety.

Described above are features that can be used singly, or in combination(s), depending on the application and the desired performance. These features include:
1) The piezoelectric member serving as a driving diaphragm as opposed to a secondary diaphragm being driven by a piezoactuator.
2) The use of two piezoelectric members in a bellows-type arrangement to simultaneously form the pressure chamber and provide the necessary cyclic volume change of the chamber.
3) Using Dynamic Vibration Absorber (DVA) and/or Reverse Vibration Absorber (RVA) amplification schemes to increase the RLP displacement and allow it to operate at much lower frequencies. Typical synthetic jets operate at Helmholtz resonant frequencies which are in the kHz range for devices of this size. A synthetic jet (SJ) being driven at kHz frequencies would be quite noisy and suppression of this noise would be difficult, if not impossible, particularly in a small package volume. Optimally the drive frequency is 60 Hz or less as this would be inaudible to humans and would allow the device to be driven directly by line voltage if necessary. Lower drive frequency synthetic jets also require less power to drive which is advantageous in battery powered applications.
4 ) The use of nozzle shaping to increase the exit air velocity such as a De Laval converging/diverging nozzle or a simple tapered nozzle. Typical devices use a straight tube as a nozzle.
5) Adding mass to the piezoelectric member to increase its deflection and lower its operating frequency.
6) Using a shim that is larger in diameter than the piezoceramic to increase deflection and/or lower its resonant frequency. This can be used in conjunction with an added mass to further increase deflection of the piezoelectric member /driving diaphragm and further lower its resonant frequency.
7) Moving the nozzle to align with the center of the piezoelectric member as opposed to the edge allows for a low profile synthetic jet which would be more ideally suited to printed circuit board (PCB) applications than a disk standing on edge protruding from the PCB.
8) Using the piezoelectric member to set up standing pressure waves in a tube with nozzles then located at the pressure anti-nodes of the standing pressure wave. This permits a single RLP to cool multiple devices and the tube could be formed to any shape to access all of the components that require cooling.
9) Optimization of a drive waveform to provide a predetermined (e.g., highest) air exit velocity from the synthetic jet nozzle(s). For example it may be beneficial to have a high dV/dt on the compression stroke and a lower dV/dt on the intake stroke.

One of the principle applications of example embodiments is in thermal management applications. In these applications the synthetic jet is used to break up the boundary layer on a part to be cooled. This allows the convective heat transfer to the surrounding atmosphere to be improved significantly. Other applications include boundary layer control on aircraft wings, cooling of LED lighting, hotspot cooling in laptop computers and portable electronic devices, and many other potential applications. There are several advantages to these devices. They can be designed to be very small thus allowing their use in portable electronic devices. They can be battery powered which again is useful in portable electronics. They produce zero net flux of the pumped gas. In other words, the intake and exhaust volumes from the device are equal on each stroke allowing the devices to be used in a sealed enclosure.

The preferred embodiment for the synthetic jet device depends on the application. In most cases a low frequency synthetic jet would be desirable due to its quiet operation and lower power consumption. The use of vibration amplification would depend on the desired flow rate in a given application and the additional complexity of the vibration amplification system may not be justified in all applications. The multi-port design of FIG. 7 is useful if multiple synthetic jets are required.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A synthetic jet comprising:
means for defining a fluid chamber, the means for defining the fluid chamber comprising at least one piezoelectric member;
a nozzle configured to provide fluid communication between the fluid chamber and external to the fluid chamber;
a drive source connected to apply an electrical signal to the piezoelectric member in a manner whereby activation of the piezoelectric member causes zero net flux of fluid with respect to the fluid chamber.

2. The apparatus of claim 1, wherein the means for defining the fluid chamber comprises a first piezoelectric member and a second piezoelectric member which have their circumferences connected together substantially entirely around a circumference of the means for defining the fluid chamber, whereby an edge of the first piezoelectric member and an edge of the second piezoelectric member exert a force against each other when displaced.

3. The apparatus of claim 2, wherein the nozzle is situated to extend through the circumference of the means for defining the fluid chamber.

4. The apparatus of claim 2, wherein the nozzle is situated to extend axially through the means for defining the fluid chamber.

5. The apparatus of claim 1, wherein the nozzle is configured to have an interior passage which in cross section is either converging, diverging, or tapered for increasing velocity of a fluid exiting through the nozzle from the fluid chamber.

6. The apparatus of claim 1, further comprising means for operating the synthetic jet at a low frequency.

7. The apparatus of claim 6, wherein the means for operating the synthetic jet at the low frequency comprises a mass connected to the piezoelectric member to increase deflection magnitude of the piezoelectric member upon activation.

8. The apparatus of claim 6, wherein the means for operating the synthetic jet at the low frequency comprises a shim positioned on the piezoelectric member to increase deflection magnitude of the piezoelectric member upon activation, the shim having a larger radius than a piezoceramic layer of the piezoelectric member.

9. The apparatus of claim 6, wherein the means for operating the synthetic jet at the low frequency comprises the drive source being configured to apply the electrical signal to the piezoelectric member so that the synthetic jet operates at a sub-KHz frequency.

10. The apparatus of claim 1, wherein the drive source is configured to apply the electrical signal having a drive waveform configured to provide a predetermined air exit velocity from the nozzle.

11. The apparatus of claim 10, wherein the drive waveform is configured to provide a higher dV/dt on a compression stroke than on an intake stroke.

12. A synthetic jet assembly comprising:
a housing configured to define a fluid chamber;
a displaceable diaphragm situated in the housing;
the housing having a port defined therein for permitting ingress and egress of fluid to the fluid chamber;
a conduit connected to the port;
a drive source connected to apply an electrical signal to the diaphragm member in a manner whereby activation of the diaphragm facilitates creation of a standing pressure wave in the conduit;
plural nozzles or orifices formed in the conduit, the plural nozzles or orifices being spaced apart at positions corresponding to pressure anti-nodes of the standing pressure wave.

13. The apparatus of claim 12, wherein the displaceable diaphragm comprises a piezoelectric member.

14. The apparatus of claim 12, wherein the conduit is configured whereby the nozzles or orifices are positioned appropriately for a given application.

15. The apparatus of claim 12, wherein the conduit is configured whereby the nozzles or orifices are positioned to cool respective plural hot spots in an electronic cooling application.

16. The apparatus of claim 12, wherein the conduit is configured whereby the nozzles or orifices are positioned to control a boundary layer on an aircraft wing.

17. A synthetic jet assembly comprising:
a housing configured to define a fluid chamber;
a displaceable diaphragm situated in the housing;
the housing having a port defined therein for permitting ingress and egress of fluid to the fluid chamber;
a conduit connected to the port;
a drive source connected to apply an electrical signal to the diaphragm member;
plural nozzles or orifices formed in the conduit;
wherein activation of the diaphragm serves to operate the plural nozzles or orifices as plural synthetic jets driven by a single actuator.

18. The apparatus of claim 17, wherein the diaphragm comprises a piezoelectric member.

19. The apparatus of claim 17, the drive source is connected to apply the electrical signal to the diaphragm member in a manner whereby the activation of the diaphragm facilitates creation of a standing pressure wave in the conduit; and
wherein the plural nozzles or orifices are spaced apart at positions corresponding to pressure anti-nodes of the standing pressure wave.
